(19) United States
(12) Patent Application Publication
(10) Pub. No.: US 2010/0254741 A1
(43) Pub. Date: Oct. 7, 2010

(54) IMAGE FORMING SYSTEM AND IMAGE FORMING APPARATUS

(75) Inventor: Yasushi Saitsu, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 12/750,978

(22) Filed: Mar. 31, 2010

(30) Foreign Application Priority Data
Apr. 2, 2009 (JP) 2009-090029

(51) Int. Cl. G03G 15/00

(52) U.S. Cl. 399/405

(57) ABSTRACT

Disclosed an image forming system including: an image forming apparatus to form an image on a sheet conveyed from a feeding section to eject the sheet; and a plurality of finishers each including one or a plurality of ejection trays, which finishers are connected to the image forming apparatus and perform finishing to the sheet ejected from the image forming apparatus, wherein the image forming apparatus includes a control section to determine a sheet feeding interval of the feeding section based on a position of the ejection tray to which a first sheet is ejected and a position of the ejection tray to which a second sheet is ejected, an image-forming order of the second sheet being immediately before an image-forming order of the first sheet.

### BACKGROUND

1. Field of the Invention

The present invention relates to an image forming system and an image forming apparatus.

2. Description of Related Art

In recent years, there has been a print-on-demand (POD) system which is provided with a plurality of finishers connected to a main body of an image forming apparatus and receives a plurality of printing reservations for sheets whose sheet ejection conditions such as finishing and an ejection tray to which a sheet is ejected are different from one another to enable executing continuous printing. A sheet conveying path and an ejection tray have been generally different for each kind of finishing. Even in the case of the same finishing, a way of using a different ejection tray for each sheet has been adopted.

In this case, when there are two sheets for which both of conveying paths and ejection trays are different from each other, and for example when printing of sheet 1 for which necessary time from feeding to ejection is five seconds and printing of sheet 2 for which the necessary time is two seconds are continuously performed and an interval between the time when the sheet 1 is fed and the time when the sheet 2 is fed is one (1) second, the sheet 2 is firstly ejected three seconds after the sheet 1 is fed, and the sheet 1 is ejected five seconds later. Here, if the sheet 1 becomes jammed immediately before (for example, four second after being fed) being ejected, the sheet 2 has been already ejected before that (three seconds after being fed). As a result, when printing restarts after jam processing, an image forming operation re-performs printing of the sheet 1 and does not re-perform printing of the sheet 2.

On the other hand, there has been provided an image forming system which performs a control to store the number of the jammed sheet to re-perform printing all of the sheets of the stored number and of the numbers after the stored number without judging whether or not reprinting needs to be performed for each sheet when printing restarts after jam processing in order to avoid a complicated control of image formation. Such system stands on the premise that the order of sheet feeding always agrees with the order of sheet ejection. Because when the sheet fed later than the jammed sheet has been already ejected, printing of the successive sheets is re-performed when the printing restarts after the jam and as a result the same page is printed duplicately. For this reason, in the above-described system, various techniques have been devised for ejecting sheets while avoiding duplicate printing of the same pages, when the jam occurs during sheet conveyance and image formation is interrupted, and when a user removes the jammed sheet to restart image formation.

Patent Document 1 (Japanese Patent Application Laid-open Publication No. 2005-289576) discloses a technique to, in the case of switching an ejection tray to which the sheet is ejected during image formation, when post-switching ejection tray is closer to an image forming apparatus than pre-switching ejection tray, after a sheet to be finally conveyed to the pre-switching ejection tray is ejected, convey a next sheet to the post-switching ejection tray.

Patent Document 2 (Japanese Patent Application Laid-open Publication No. 2005-225573) discloses a technique to determine waiting time for resist processing depending on sheet sizes and the like of a plurality of sheets on which images are formed.

### SUMMARY

However, since the technique of Patent Document 1 sets a sheet feeding interval before and after switching of the ejection tray to a fixed value, the sheet feeding interval needs to be set to be the largest difference of necessary time for conveyance between a combination of ejection trays among a plurality of combinations. When an actual difference of necessary time for conveyance at the time when the ejection tray is changed is small, there is a possibility that wasted waiting time occurs. Although the technique of Patent Document 2 can wait resist processing depending on a transfer sheet size and the like, waiting time occurs similarly to the above so that image forming efficiency is reduced. For this reason, in order to prevent the image forming efficiency from reducing, when changing the ejection tray, combinations of finishers before and after the changing have to be restricted.

According to a first aspect of the present invention, there is disclosed an image forming system including: an image forming apparatus to form an image on a sheet conveyed from a feeding section to eject the sheet; and a plurality of finishers each including one or a plurality of ejection trays, which finishers are connected to the image forming apparatus and perform finishing to the sheet ejected from the image forming apparatus, wherein the image forming apparatus includes a control section to determine a sheet feeding interval of the feeding section based on a position of the ejection tray to which a first sheet is ejected and a position of the ejection tray to which a second sheet is ejected, an image-forming order of the second sheet being immediately before an image-forming order of the first sheet.

According to a first aspect of the present invention, there is disclosed an image forming apparatus which is connected to a plurality of finishers each including one or a plurality of ejection trays so as to enable a data transmission and reception, and which apparatus forms an image on a sheet conveyed from a feeding section to eject the sheet, the image forming apparatus including: a control section to determine a sheet feeding interval of the feeding section based on a position of the ejection tray to which a first sheet is ejected and a position of the ejection tray to which a second sheet is ejected, an image-forming order of the second sheet being immediately before an image-forming order of the first sheet.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein:

FIG. 1 is a system configuration diagram of an image forming system according to the embodiment;

FIG. 2 is a block diagram of each apparatus shown in FIG. 1;

FIG. 3 is a flowchart showing processing of determining feeding interval to be performed in an image forming apparatus;

FIG. 4 is a flowchart showing processing of transmitting necessary time for conveyance to be performed in a finisher;

FIG. 5 is a ladder diagram showing a flow of data in the image forming system when the processing of determining feeding interval and the processing of transmitting necessary time for conveyance are performed;

FIG. 6 is a ladder diagram showing a flow of data in the image forming system when the processing of determining feeding interval and the processing of transmitting necessary time for conveyance are performed;

FIG. 7 is a flowchart showing processing B of determining feeding interval to be performed in the image forming apparatus; and

FIG. 8 is a flowchart showing the processing of transmitting necessary time for conveyance to be performed in the image forming apparatus.

### DETAILED DESCRIPTION OF THE PREFERRED EMBODIMENT

### First Embodiment

Although embodiments of the present invention will be described below with reference to the drawings, the present invention is not limited to the following embodiments. The embodiments are intended to show the best modes for implementing the present invention and are not intended to limit the scope of the present invention.

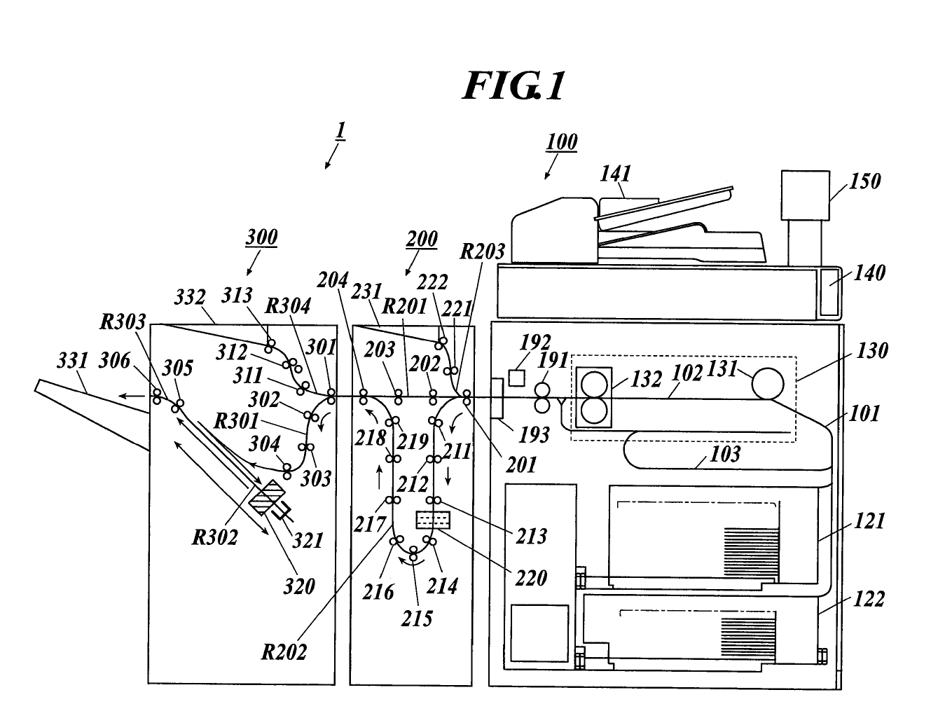

A configuration of an image forming system according to the embodiment will be firstly described. As shown in FIG. 1, the image forming system 1 includes an image forming apparatus 100, a first finisher 200 and a second finisher 300.

The image forming apparatus 100 includes storage sections 121, 122, an image forming section 130, and image reading section 140, an auto document conveying section 141, a display/operation section 150, a sheet ejection roller 191, a sheet ejection sensor 192, a sheet ejection exit 193, and so on. The image forming apparatus 100 further includes a conveying path 101 for feeding sheets from the storage sections 121, 122 to the image forming section 130, a conveying path 102 extending from the image forming section 130 to the sheet ejection exit 193 though the sheet ejection roller 191, and a conveying path 103 for turning over the side of the sheet, as sheet conveying paths.

The storage sections 121, 122 store sheets on which images have not been formed while sorting them into kinds of sheets such as sheet type and sheet size. Specifically, the kinds of sheets to be stored in the storage sections 121, 122 include paper with a tab which includes a tab on a side in a longitudinal direction of the paper, plain paper which does not especially include tabs or the like, a back side of used paper, recycled paper, fine paper, thick paper and so on.

The image forming section 130 exposes/scans a photoreceptor 131 with laser beam emitted from an exposing section (not shown) based on image data to form an electrostatic image. Then, a developing section (not shown) allows toner to stick to the photoreceptor 131, and a transferring section (not shown) allows the toner to be transferred to the sheet. After that, a fixing section 132 allows the toner to be heat fixed on the sheet to form the image. Although the configuration of the image forming section 130 performing image formation by the above-described electrophotography process is described as an example, the image formation may be performed also by an ink-jet method, thermal transfer method, and the like.

The image reading section 140 reads an original document placed on a reading tray and the like as image data. Specifically, the image reading section 140 irradiates the document placed on an image reading board (not shown) with light from a light source and reads reflected light from the document by Charge Coupled Device (CCD). In the case of using the auto document conveying section 141, one document each is conveyed from a document bundle set in the auto document conveying section 141 to the reading board of the image reading section 140 which reads the image.

The display/operation section 150 is equipped with various operation keys such as numeric key, start key, function keys for various setting regarding image formation. The display/operation section 150 is further equipped with a touch panel integrally formed with a display screen such as Liquid Crystal Display (LCD). The touch panel detects a position touched with a fingertip of a user or touch pen to receive an operation instruction from a user.

In the image forming system 1, a user can input an instruction as to image formation by the image forming system 1, a print request for starting a job, and an instruction for changing various settings by operating the operation keys or the touch panel of the display/operation section 150.

The instruction as to image formation by the display/operation section 150 relates to image formation on both sides or on single side of the sheet, an ejection tray to which the sheet is ejected in the case of ejecting the sheet outside of the apparatus, finishing contents (stapling, punching and the like) to be performed to the image-formed sheet, a size of the sheet to be image-formed, and so on. These pieces of information are managed while being included in sheet information.

The sheet ejection roller 191 is driven to rotate by a drive source (not shown) such as a motor. The sheet ejection roller 191 is driven to rotate to convey the image-formed sheet to the sheet ejection exit 193. The sheet ejection sensor 192 is a sensor to detect whether or not the sheet exists. The sheet ejection sensor 192 is placed in the vicinity of the sheet ejection exit 193, and detects positions of a leading end and tail end in a conveying direction of the sheet to be ejected from the sheet ejection exit 193.

The first finisher 200 performs finishing to the sheet which the image forming apparatus 100 ejected. The first finisher 200 includes conveying rollers 201-204, conveying rollers 211-219, conveying rollers 221, 222, which are connected to a drive source (not shown) such as a motor, a finishing section 220 and a sub tray 231, for conveying the sheet. The finishing section 220 performs finishing such as punching to the leading end in the conveying direction of the sheet to be conveyed. The sub tray 231 is an ejection tray for collecting the sheet which is ejected outside to be placed thereon.

As sheet conveying paths of the first finisher 200, a conveying path R201 through which the sheet is conveyed by the conveying rollers 201, 202, 203 and 204 in this order, a conveying path R202 through which the sheet is conveyed by the conveying rollers 201, 211-219 and 204 in this order, and a conveying path R203 through which the sheet is conveyed by the conveying rollers 201, 221 and 222 in this order.

The conveying path R201 is a path for ejecting the sheet conveyed from the image forming apparatus 100 to the second finisher 300 without finishing to the sheet.

The conveying path R202 is a path which is provided with the finisher 220 in the middle of the path and can perform finishing to the sheet conveyed from the image forming apparatus 100.

The conveying path R203 is a path for ejecting the sheet conveyed from the image forming apparatus 100 to the sub tray 231 without finishing to the sheet.

The second finisher 300 is provided via the first finisher 200 to perform finishing to the sheet routed through the first finisher 200. The second finisher 300 includes conveying rollers 301-306 and conveying rollers 311-313, which are connected to a drive source (not shown) such as a motor, a finishing section 320, a stopper 321, and a main tray 331 and a sub tray 332 which are ejection trays to correct the sheet which is ejected outside to be placed thereon.

The finisher 320 performs finishing such as stapling to the tail end in the conveying direction of the conveyed sheet. The stopper 321 retains the conveyed in the conveying order. When the stopper 321 retains a plurality of sheets, the second finisher 300 can perform finishing by the finishing section 320 to a sheet bundle of the plurality of sheets.

As sheet conveying paths of the second finisher 300, there are conveying paths R301, R302 and R303 which are paths for ejecting the sheet to the main tray 331 and though which the sheet is conveyed by the conveying rollers 301-306 in this order, and a conveying path R304 which are paths for ejecting the sheet to the sub tray 332 and through which the sheet is conveyed by the conveying rollers 301 and 311-313 in this order. The conveying path R302 is provided with the finishing section 320 and the stopper 321.

Since the path for conveying the sheet to the main tray 331 goes through the conveying path R302, finishing can be performed to the sheet conveyed from the first finisher 200.

The conveying path R304 for ejecting the sheet to the sub tray 332 ejects the sheet conveyed from the first finisher 200 without performing finishing.

Incidentally, a connection layout between apparatuses of the image forming system 1 is not especially limited to the above-described one. The number of finishers contained in the image forming system 1 is not limited to two (2). A layout where a further finisher to perform a different finishing is included in addition to the above-described first finisher 200 and second finisher 300, or a layout where an arbitrary number of high-capacity sheet ejection stackers are connected may be adopted.

Although the image forming system 1 has a system configuration where a plurality of apparatuses are connected, the image forming system 1 may be one image forming apparatus which includes the plurality of apparatus as one unit.

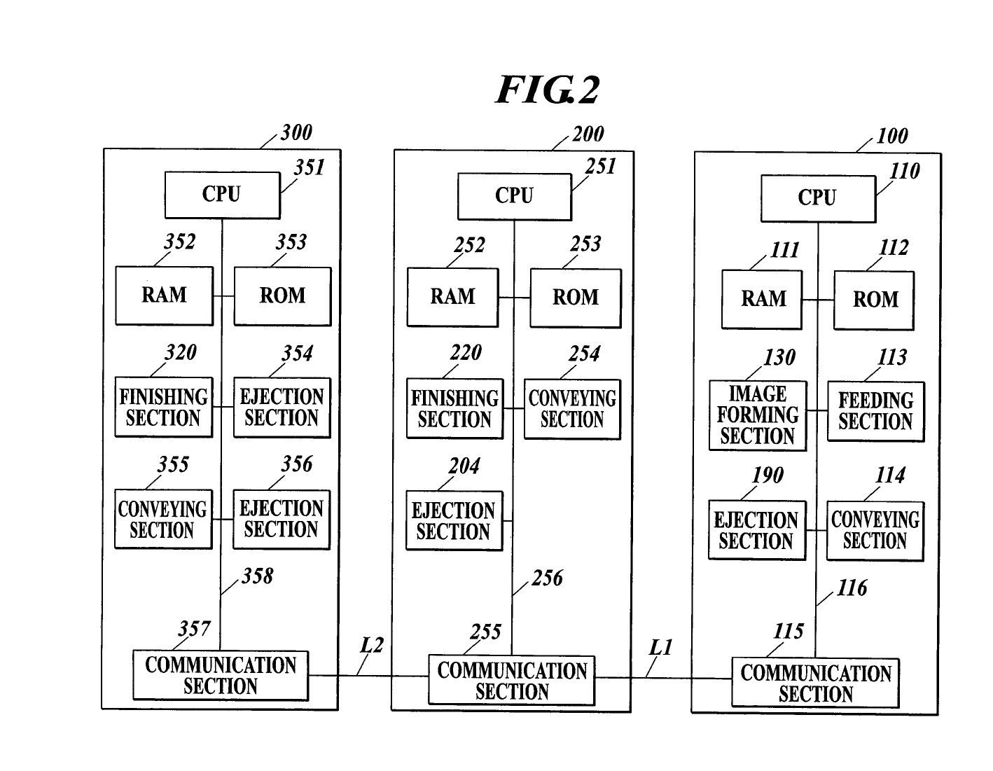

Next, a functional configuration of the image forming system 1 will be described. As shown in FIG. 2, the image forming apparatus 100 and the first finisher 200 are connected to each other via a communication line L1 so as to communicate with each other. The first finisher 200 and the second finisher 300 are connected to each other via a communication line L2 so as to communicate with each other.

In other words, the image forming system 1 has a configuration where the image forming apparatus 100, the first finisher 200 and the second finisher 300 are dependently connected to one another via the communication lines L1, L2. As the connection layout of the image forming system 1, a star-connection may be adopted for example, and the layout is not especially limited. The communication by the image forming system 1 may be a wireless communication or infrared communication instead of the wire communication using the communication lines L1, L2.

The image forming apparatus 100 has a configuration to include: a Central Processing Unit (CPU) 110, a Random Access Memory (RAM) 111, a Read Only Memory (ROM) 112, a feeding section 113, a conveying section 114, a communication section 115, an image forming section 130, and an ejection section 190. The sections of the image forming apparatus 100 are connected to one another via a bus 116.

The CPU 110 collectively controls the sections of the image forming apparatus 110. The CPU 110 expands specified program data among various pieces of program data stored in the ROM 112 to the RAM 111, and executes various processings in cooperation with the program data expanded in the RAM 111.

The feeding section 113 feeds the sheet stored in the storage sections 121, 122 to the image forming section 130 through the conveying section 114 by the control of the CPU 110. The conveying section 114 includes a drive source (not shown) such as a motor to drive under the control of the CPU 110, and conveys the sheet through the above-described conveying paths 101, 102 and 103. The communication section 115 is a communication interface to execute a parallel communication or serial communication via the communication line L1. The ejection section 190 includes the above-described sheet ejection roller 191, sheet ejection sensor 192 and sheet ejection exit 193, and ejects the sheet image-formed by the image forming section 130 outside of the apparatus.

The first finisher 200 has a configuration to include a CPU 251, a RAM 252, a ROM 253, a finisher 220, a conveying section 254, an ejection section 204 and a communication section 255. These sections of the first finisher 200 are connected to one another via the bus 256.

The CPU 251 collectively controls the sections of the first finisher 200. The CPU 251 expands specified program data among various pieces of program data stored in the ROM 253 to the RAM 252, and executes various processings in cooperation with the program data expanded in the RAM 252.

The conveying section 254 is composed of the above-described conveying paths R201, R202 and R203, and conveys the sheet under the control of the CPU 251. The ejection section 204 is composed of the above-described sub tray 231, the conveying roller 304 for ejecting the sheet to the second finisher 300, and the like, and ejects the sheet outside of the apparatus or to the second finisher 300 connected to its own apparatus under the control of the CPU 251. The first finisher 200 includes a sensor (not shown) to detect a sheet ejection to the second finisher 300.

The second finisher 300 has a configuration to include a CPU 351, a RAM 352, a ROM 353, a finisher 320, a conveying section 354, an ejection section 355, an ejection section 356, and a communication section 357. The sections of the second finisher 300 are connected to one another via a bus 358.

The CPU 351 collectively controls the sections of the second finisher 300. The CPU 351 expands specified program data among various pieces of program data stored in the ROM 353 to the RAM 352, and executes various processings in cooperation with the program data expanded in the RAM 352.

The information of the second finisher 300 includes configuration information specific to its own apparatus which contains kinds of finishing (stapling, punching and the like) executable in the finishing section 320 and execution positions (leading end in the conveying direction/tail end) of finishing to the sheet, and position information which contains an installation position of the second finisher 300 in the image forming system 1 (how many apparatuses there are from the image forming apparatus 100 to the second finisher 300).

The conveying section 354 is composed of the above-described conveying paths R301, R302, R303 and R304, and conveys the sheet under the control of the CPU 351.

Next, an operation will be described.

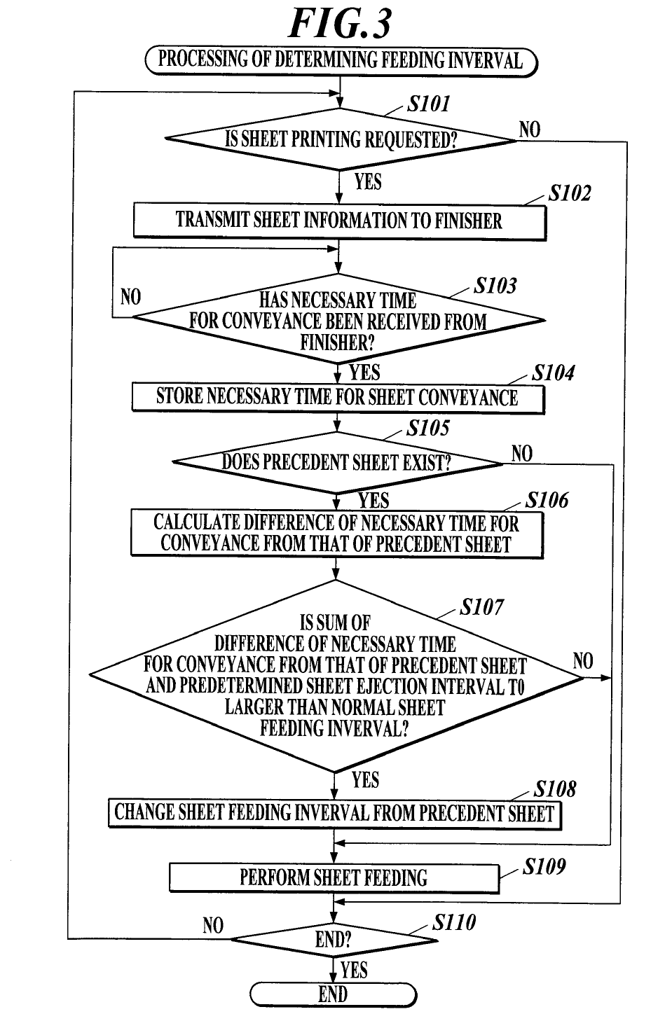

FIG. 3 shows a flowchart of processing of determining the feeding interval to be performed in the image forming apparatus 100. The processing of determining the feeding interval is performed by the CPU 110 in cooperation with the program stored in the ROM 112.

Firstly, it is judged whether or not a sheet print request is input (Step S101). The print request is input from the display/operation section 150 and the like. When it is not judged that the print request is input (Step S101; NO), it is judged whether or not the job ends (Step S110). When it is not judged that the job ends (Step 110; NO), the processing returns to Step S101, and whether or not a sheet print request is input is judged again.

When it is judged that the print request is input (Step S101; YES), the sheet information (ejection tray to which the sheet is ejected/finishing content/sheet size) is transmitted to the finishing section (Step S102). The sheet information is expanded in the RAM 111 and the like for each sheet on the basis of the input from the display/operation section 150 and the like. By the input from the display/operation section 150 and the like, it is possible to read the sheet information from the ROM 112 and the like to expand the read sheet information in the RAM 11 to appropriately change values such as a value regarding the ejection tray to which the sheet ejected. In the embodiment, the sheet information is transmitted to the first finisher 200 connected to the image forming apparatus 110 via the communication line L1.

Then, it is judged whether or not a necessary time for conveyance has been received from the finisher (Step S103). In the embodiment, whether the necessary time for conveyance calculated by performing the processing of transmitting the necessary time for conveyance described below has been received from the first finisher 200 or not is judged.

When it is not judged that the necessary time for conveyance has been received (Step S103; NO), the processing returns to Step S103, and whether or not the necessary time for conveyance has been received is judged again.

When it is judged that the necessary time for conveyance has been received (Step S103; YES), the received necessary time for conveyance is stored in the RAM 111 (Step S104). The necessary time for conveyance to be stored in the RAM 111 in Step S104 is a necessary time for conveyance corresponding to the sheet for which the sheet information was transmitted in Step S102. In Step S104, the necessary time for conveyance is correlated to the order of sheet printing to be stored therewith in the RAM 111.

It is judged whether or not the precedent sheet exists (Step S105). The precedent sheet is a sheet which is earlier in the printing order, for example the first sheet with respect to the second sheet. With respect to the first sheet, there is no precedent sheet.

When it is judged the precedent sheet exists (Step S105; YES), a difference of the necessary time for conveyance from that of the precedent sheet is calculated (Step S106). Specifically, the difference between the necessary time for conveyance of the precedent sheet which was stored in the RAM 111 and the necessary time for conveying the sheet for which the sheet information was transmitted in Step 102 is calculated.

It is judged whether or not the sum of the difference of the necessary time for conveyance from that of the precedent sheet and a predetermined sheet ejection interval is larger than a normal sheet feeding interval (paper feeding interval) (Step S107). The normal sheet feeding interval is a previously-set default value and stored in the ROM 112.

When it is judged that the sum is larger than the normal sheet feeding interval (Step S107; Yes), the sheet feeding interval from the precedent sheet is changed (Step S108).

When it is not judged that the precedent sheet exists (Step S105; NO) or it is not judged that the sum is larger than the normal sheet feeding interval (Step S107; NO), the sheet feeding section 113 performs sheet feeding (paper feeding) (Step S109). When the sheet feeding interval is changed in Step S108, paper feeding is performed based on the changed sheet feeding interval.

It is judged whether or not the job ends (Step S110). When it is not judged that the job ends (Step S110; NO), the processing returns to Step S102 and the sheet information (ejection tray to which the sheet is ejected/finishing content/sheet size) is transmitted to the finisher. When it is judged that the job ends (Step S110; YES), the processing ends.

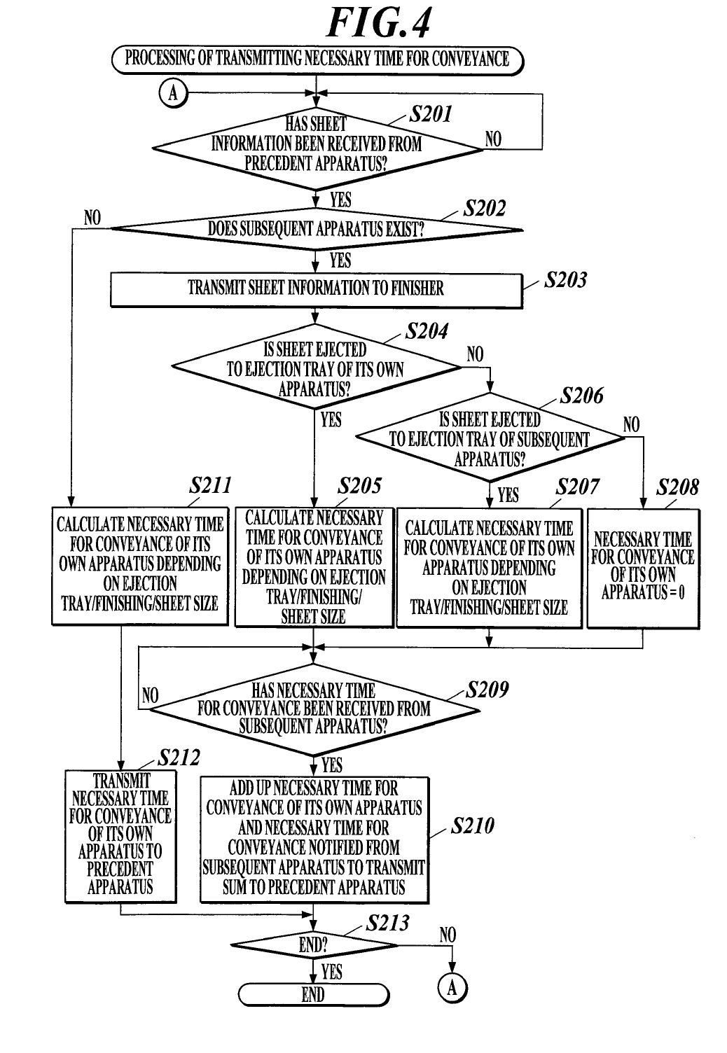

FIG. 4 shows a flowchart of the processing of transmitting the necessary time for conveyance to be performed in the first finisher 200 or the second finisher 300. The processing of transmitting the necessary time for conveyance is performed by the CPU 251 in cooperation with the program stored in the ROM 253. Hereinafter, the processing of transmitting the necessary time for conveyance to be performed by the first finisher 200 will be described as an example, and the similar processing is performed also in the second finisher 300.

Firstly, it is judged whether or not the sheet information has been received from the precedent apparatus (Step S201). The precedent apparatus is an apparatus to convey the sheet to the finisher which performs the processing of transmitting the necessary time for conveyance. In the case of the first finisher 200, the precedent apparatus is the image forming apparatus 100, and in the case of the second finisher 300, the precedent apparatus is the first finisher 200. When it is not judged that the sheet information has not been received (Step S201; NO), the processing returns to Step S201, and whether or not the sheet information has been received is judged again.

When it is judged that the sheet information has been received (Step S201; YES), it is judged whether or not a subsequent apparatus exists (Step S202). The subsequent apparatus is other apparatus to which the finisher performing the processing of transmitting the necessary time for conveyance can eject the sheet. In the case of the first finisher 200, the subsequent apparatus is the second finisher 300. In the case of the second finisher 300, there is no subsequent apparatus.

When it is judged that the subsequent apparatus exists (Step S202; YES), the received sheet information (ejection tray to which the sheet is ejected/finishing content/sheet size) is transmitted to the subsequent apparatus (Step S203). Based on the received sheet information, it is judged whether or not the sheet is ejected to the ejection tray of its own apparatus (Step S204).

When it is judged that the sheet is ejected to the ejection tray of its own apparatus (Step S204; YES), the necessary time for conveyance of its own apparatus is calculated depending on the sheet information (ejection tray to which the sheet is ejected/finishing content/sheet size) (Step S205). Specifically, the necessary time from the time when the first finisher 200 receives the leading end of the sheet from the image forming apparatus 100 to the time when the tail end of the sheet is ejected from the first finisher is calculated. This necessary time is calculated based on various pieces of information included in the sheet information, for example, calculated by referring to a numerical expression obtained by weighting each value of the information, or referring to Look Up Table (LUT). The same can be said for the case that the processing of transmitting the necessary time for conveyance is performed in the second finisher 300.

When it is not judged that the sheet is ejected to the ejection tray of its own apparatus (Step S204; NO), it is judged whether or not the sheet is ejected to the ejection tray of the subsequent apparatus (Step S206).

When it is judged that the sheet is ejected to the ejection tray of the subsequent apparatus (Step S206; YES), the necessary time for conveyance of its own apparatus is calculated depending on the sheet information (ejection tray to which the sheet is ejected/finishing content/sheet size) (Step S207). Specifically, the interval from the time when the first finisher 200 receives the leading end of the sheet from the image forming apparatus 100 to the time when the lending end of the sheet is ejected to the second finisher 300 is calculated. This necessary time is calculated on the basis of the values included in the sheet information similarly to Step S205.

When it is judged that the sheet is ejected to the ejection tray of the subsequent apparatus (Step S206; NO), since the sheet is not conveyed through its own apparatus, the number of zero (0) is assigned to the necessary time for conveyance of its own apparatus (Step S208).

It is judged whether or not the necessary time for conveyance has been received from the subsequent apparatus (Step S209). It is not judged that the necessary time has been received (Step S209; NO), the processing returns to Step S209, and whether or not the necessary time for conveyance has been received is judged again.

When it is judged that the necessary time has been received (Step S209; YES), the necessary time for conveyance of its own apparatus and the necessary time for conveyance notified from the subsequent apparatus are added up to be transmitted to the precedent apparatus (Step S210), and the processing ends.

On the other hand, when it is not judged that the subsequent apparatus exists (Step S202; NO), the necessary time for conveyance of its own apparatus is calculated depending on the sheet information (ejection tray to which the sheet is ejected/finishing content/sheet size) (Step S211). Specifically, in the case that the second finisher 300 is not connected to the first finisher 200 or the like, the necessary time from the time when the first finisher 200 receives the leading end of the sheet from the image forming apparatus 100 to the time when the tail end of the sheet is ejected from the first finisher is calculated. This necessary time is calculated on the basis of the values included in the sheet information similarly to Step S205. Also a numerical expression obtained by weighting differently from Step S205 and the like may be used for calculating.

The calculated necessary time for conveyance of its own apparatus is transmitted to the precedent apparatus (Step S212). It is judged whether or not an end instruction is input to the CPU 251 (Step S213). When it is not judged the end instruction is input (S213; NO), the processing returns to Step S201, and it is judged whether or not the sheet information has been received from the precedent apparatus.

When it is judged that the end instruction is input (Step 213; YES), the processing ends.

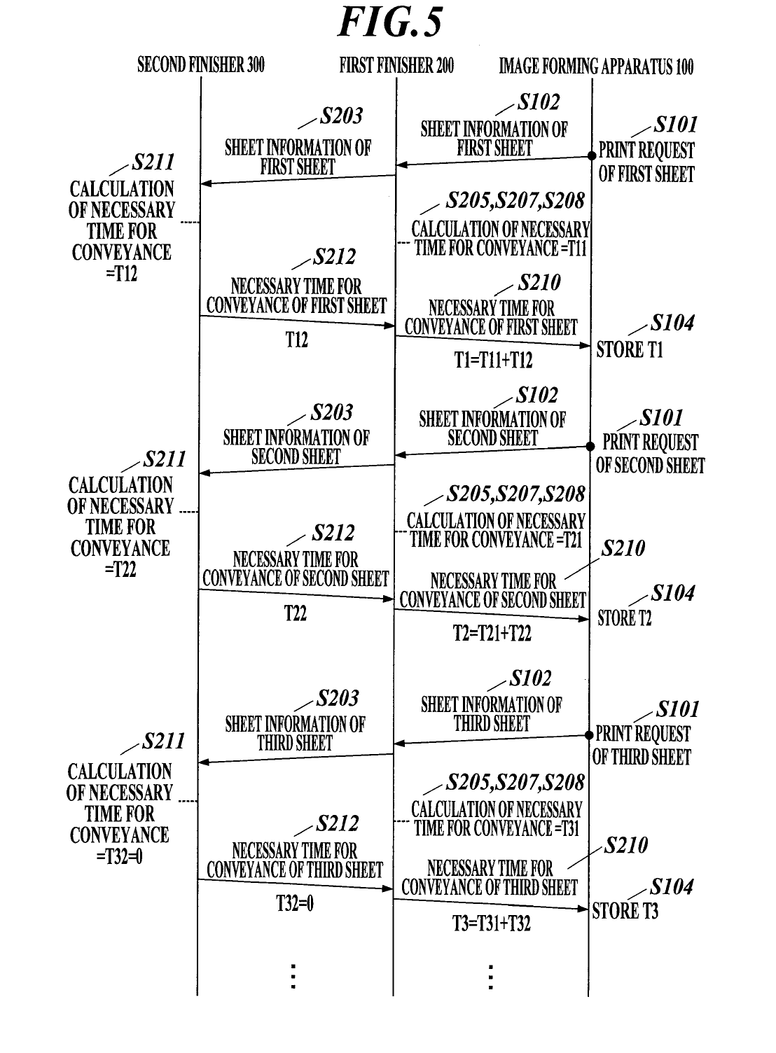

FIG. 5 shows a flow of data between the apparatuses constituting the image forming system 1 when the image forming apparatus 100 performs the processing of determining the feeding interval and the first finisher 200 and the second finisher 300 perform the processing of transmitting the necessary time for conveyance.

As shown in FIG. 5, when the image forming apparatus 100 receives the print request in Step S101, the sheet information is transmitted to the first finisher 200 in Step S102. In Step S203, the first finisher 200 transmits the sheet information to the second finisher 300.

The second finisher 300 calculates the necessary time for conveyance (herein after referred to as necessary time T12 for conveyance) in Step S211, and transmits the necessary time T12 for conveyance to the first finisher 200 in Step S212.

The first finisher 200 calculates the necessary time for conveyance (hereinafter referred to as necessary time T11 for conveyance) in Steps S205, 5207 or 5208, and in Step S210, adding up necessary times Til, T12 for conveyance to transmit the sum (hereinafter referred to as necessary time T1 for conveyance) to the image forming apparatus 100. In Step S104, the image forming apparatus 100 stores the necessary time T1 for conveyance in the RAM 111.

When there are a plurality of sheets to be printed of the job, the above processing is repeated a number of times same as the number of sheets. As shown in FIG. 5, also for the second sheet, the necessary times T21, T22 for conveyance are calculated to store the necessary time T2 for conveyance. Also for the third sheet and its subsequent sheets, the necessary times T31, T32 for conveyance are calculated to store the necessary time T3 for conveyance.

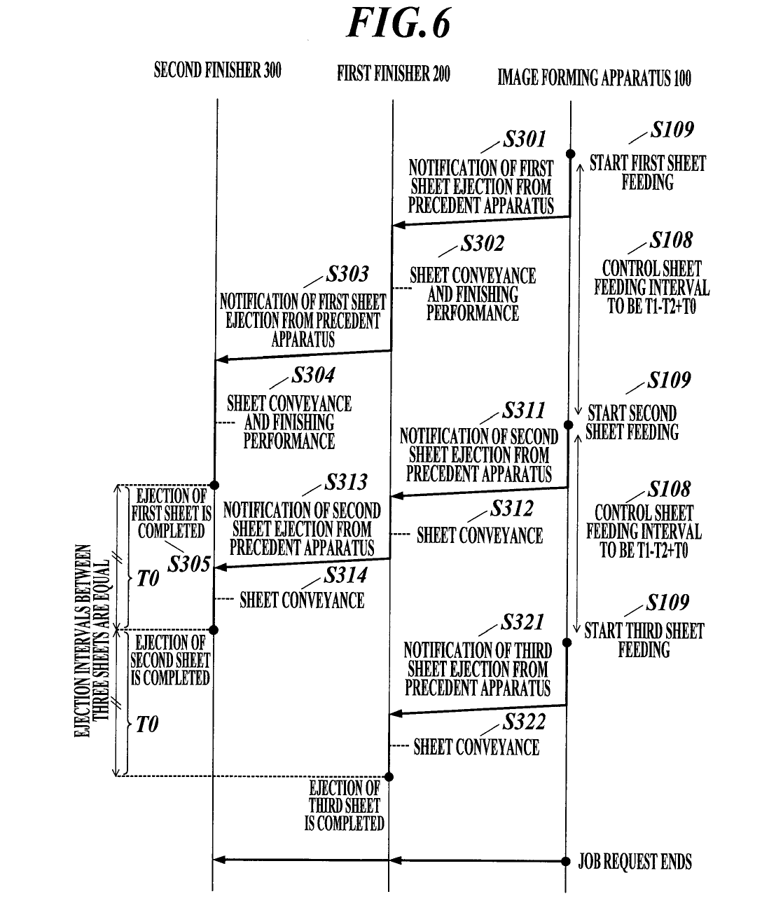

FIG. 6 shows a flow of the processing from starting sheet feeding in Step S109 to forming an image on the sheet to eject the image-formed sheet.

As shown in FIG. 6, sheet feeding of the first sheet is started in Step S109, the image forming section 130 forms an image on the sheet, and the sheet is ejected to the first finisher 200. At that time, the image forming apparatus 100 transmits a notification of sheet ejection from the precedent apparatus to the first finisher 200 (Step S301). The notification of sheet ejection from the precedent apparatus is transmitted by the control of the CPU 110 when the sheet ejection sensor 192 detects the sheet ejection.

When the first finisher 200 receives the notification of sheet ejection from the precedent apparatus and receives the sheet from the image forming apparatus 100, sheet conveying and finishing are performed to the sheet (Step S302). When the sheet is ejected to the second finisher 300, the notification of sheet ejection from the precedent apparatus is transmitted from the first finisher 200 to the second finisher 300 (Step S303). Also this notification of sheet ejection from the precedent apparatus is transmitted by the control of the CPU 251 when the first finisher 200 detects the sheet ejection by a sheet ejection sensor (not shown) similarly to the above.

When the second finisher 300 receives the notification of sheet ejection from the precedent apparatus and receives the sheet from the first finisher 200, sheet conveying and finishing are performed to the sheet (Step S304). The sheet to which finishing is performed is ejected to the ejection section 355 or the ejection section 356 (Step S305).

The sheet ejection interval between the first sheet and the second sheet is changed to be T1−T2+T0 where T0 is a predetermined sheet ejection interval in Step S108. The sheet ejection interval between the second sheet and the third sheet is changed to be T2−T3+T0 in Step S108. When the sheet ejection intervals are changed in this way, the interval from the end of the first sheet ejection to the end of the second sheet ejection becomes equal to the interval from the end of the second sheet ejection to the end of the third sheet ejection (both become the predetermined sheet ejection interval T0). In the example shown in FIG. 6, the first and second sheets are ejected to the second finisher 300, and the third sheet is ejected to the first finisher 200.

Incidentally, when the value of T1−T2+T0 or the value of T2−T3+T0 is the default value or more, the sheet feeding interval between the first sheet and the second sheet becomes the default value by judgment in Step S107. The same can be said for the fourth sheet and the subsequent sheets thereof.

As described above, according to the image forming system of the embodiment, the feeding section can feed the sheets at different timings for each sheet. By feeding each sheet at different timing, it becomes possible to prevent the order of sheets to be ejected to the ejection section of the finisher from interchanging. In addition, the sheet ejection intervals become equal to one another so that productivity of the job improves, the job including the sheet to be ejected to the ejection tray closer to the image forming apparatus than that to which the precedent sheet is ejected. In other words, since the sheet feeding interval is different for each combination of the ejection trays to which the sheets whose image-forming orders are successive are ejected respectively, the sheet ejection interval for ejecting the image-formed sheets can be equal regardless of the combination of the ejection trays. Thus, wasted waiting time can be prevented especially in the case that the ejection trays to which the sheets to be continuously image-formed are ejected respectively are away from each other in the image forming system where a number of finishers are provided and there are a number of ejection trays to which the sheets are ejected, and thereby the productivity of the job improves.

Moreover, the image forming apparatus can determine the sheet feeding interval based on the information received from the finisher to eject the sheet to the finisher.

The above description of the embodiment is merely an example of the preferred image forming apparatus according to the present invention, and the present invention is not limited to the above. For example, though the embodiment calculates the necessary time for conveyance of the finisher based on the sheet information including the information of the ejection tray to which the sheet is ejected so as to determine the sheet feeding interval based on the necessary time for conveyance, the configuration is not limited to the above as long as the sheet feeding interval can be determined depending on the combination of the ejection trays to which the sheets are ejected. For example, the configuration where a table in which the combinations of ejection trays to which the sheets are ejected are respectively correlated to the sheet feeding intervals is previously stored and the sheet feeding interval is determined by referring to the table may be adopted.

Furthermore, as a computer-readable medium other than the ROM of the embodiment, a nonvolatile memory including a flash memory such as a Secure Digital (SD) card and a Universal Serial Bus (USB) memory, and a portable recording medium such as a CD-ROM may be applied. It is also possible to provide the various pieces of data of the present invention such as program data and voice data through the communication line while being superimposed on a carrier wave.

Also other detailed operation of the image forming system can be appropriately changed without departing from the spirit of the present invention.

### Second Embodiment

Next, the second embodiment of the image forming system 1 according to the present invention will be described. The second embodiment is different from the first embodiment in the point that the necessary time for conveyance is calculated in the image forming apparatus 100. Hereinafter, the processing of determining the feeding interval (referred to as processing B of determining the feed interval in order to distinguish from the first embodiment) for determining the sheet feeding interval and the processing of calculating the necessary time for conveyance will be described.

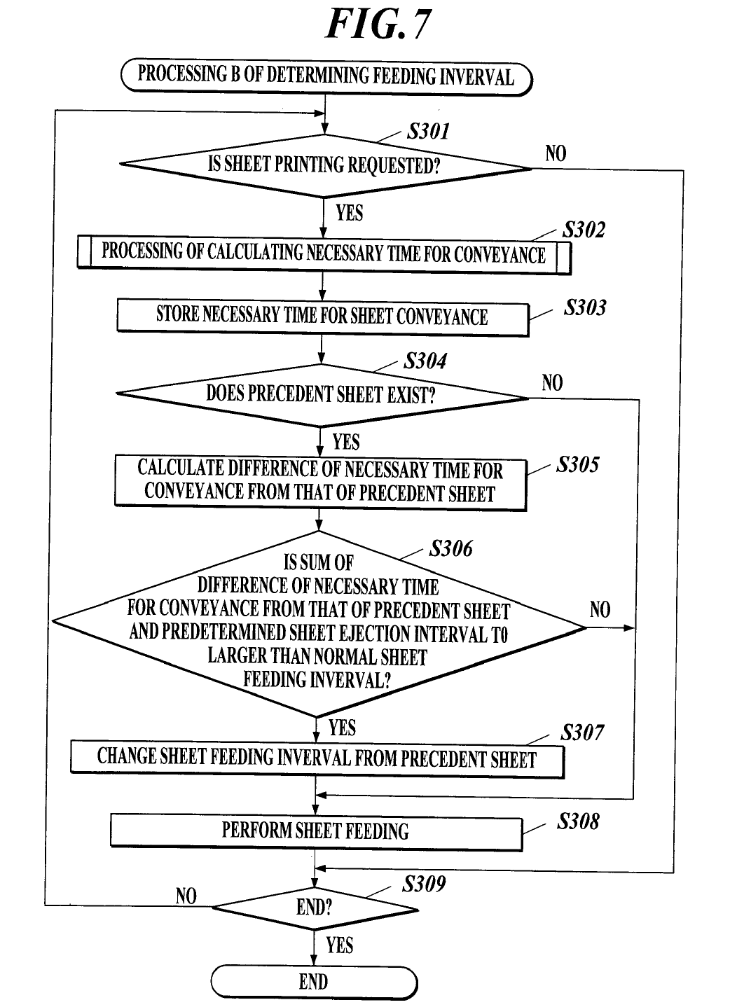

FIG. 7 shows a flowchart of the processing B of determining the feeding interval to be performed in the image forming apparatus 100. The processing B of determining the feeding interval is performed by the CPU 110 in cooperation with the program stored in the ROM 111.

Firstly, it is judged whether or not the sheet print request is input (Step S301). When it is not judged that the print request is input (Step S301; NO), it is judged whether or not the job ends (Step S309). When it is not judged that the job ends (Step S309; NO), the processing returns to Step S301, and whether or not the print request is input is judged again.

When it is judged that the print request is input (Step S301; YES), the processing of calculating the necessary time for conveyance is performed (Step S302).

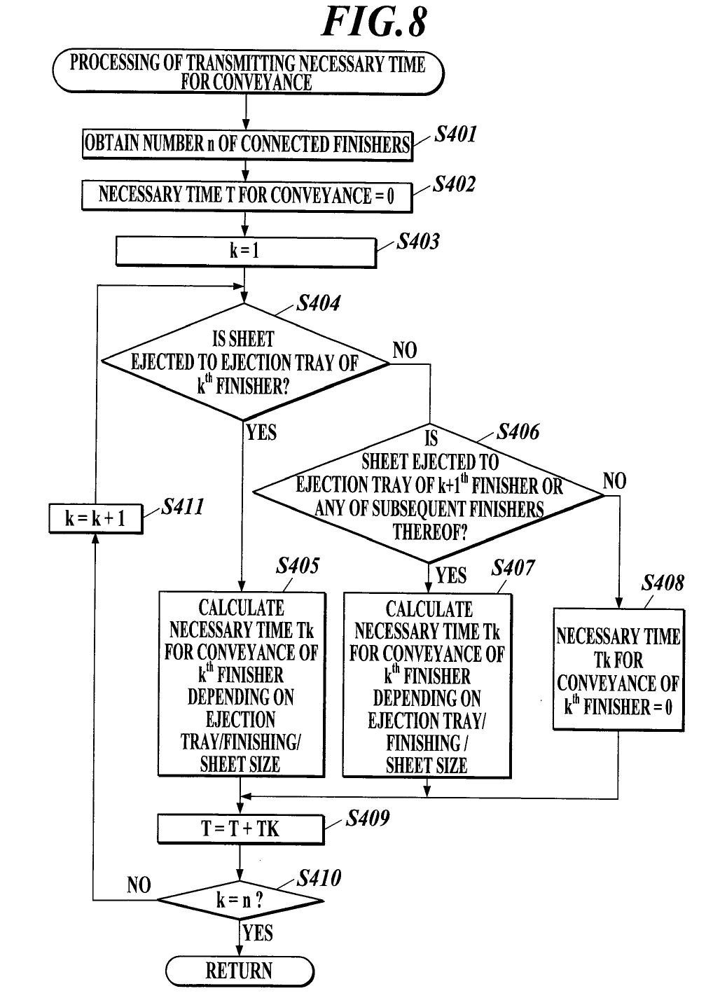

FIG. 8 shows a flowchart of the processing of calculating the necessary time for conveyance to be performed in Step S302. The processing of calculating the necessary time for conveyance is performed by the CPU 110 in cooperation with the program stored in the ROM 112.

Firstly, the number of finishers connected to the image forming apparatus 100 is obtained (Step S401). The number of zero (0) is assigned to the necessary time T for conveyance (Step S402). The number of one (1) is assigned to a counter parameter k (Step S403).

It is judged whether or not the ejection tray to which the sheet is ejected is an ejection tray of k^{th} finisher based on the sheet information (Step S404). When it is judged that it is the ejection tray of the k^{th} finisher (Step S404; YES), the necessary time Tk for conveyance of the k^{th} finisher is calculated depending on the sheet information (ejection tray to which the sheet is ejected/finishing content/sheet size) (Step S405). Specifically, the necessary time from the time when the k^{th} finisher receives the leading end of the sheet to the time the tail end of the sheet is ejected from the k^{th} finisher is calculated. This necessary time is calculated based on the values included in the sheet information similarly to Step S205, for example, calculated by referring to a numerical expression obtained by weighting the values or a Look Up Table (LUT).

When it is not judged that it is the ejection tray of the k^{th} finisher (Step S404; NO), it is judged whether or not the sheet is ejected to the ejection tray of (k+1)^{th} finisher or its subsequent finishers (Step S406).

When it is judged that it is the ejection tray of (k+1)^{th} finisher or its subsequent finishers (Step S406; YES), the necessary time Tk for conveyance of the k^{th} finisher is calculated depending on the sheet information (ejection tray to which the sheet is ejected/finishing content/sheet size) (Step S407). Specifically, the interval from the time when the k^{th} finisher receives the leading end of the sheet to the time when the leading end of the sheet is ejected to the (k+1)^{th} finisher. This necessary time is calculated based on the values included in the sheet information similarly to Step S205.

When it is not judged that it is the (k+1)^{th} finisher or its subsequent finishers (Step S406; NO), since the sheet is not conveyed through the k^{th} finisher, the number of zero (0) is assigned to the necessary time Tk for conveyance of the k^{th} finisher (Step S408).

Then Tk is added to the necessary time T for conveyance (Step S409). It is judged whether or not the counter parameter k is equal to a value of n (Step S410). When it is not judged that the counter parameter k is equal to the value of n (Step S410; NO), the counter parameter is incremented by one (1) (Step S411).

When it is judged that the counter parameter k is equal to the value of n (Step S410; YES), the processing of calculating the necessary time for conveyance ends and the processing returns to Step S303.

Since Steps S303-S309 of FIG. 7 are respectively similar to Steps S104-S110, an explanation is omitted.

As described above, according to the image forming apparatus of the embodiment, the sheet feeding interval of the sheet feeding section can be determined by the processing B of determining the feeding interval and the processing of calculating the necessary time for conveyance. In other words, the finishers do not need to perform processing of determining the sheet feeding interval.

Also other detailed operation of the image forming system can be appropriately changed without departing from the spirit of the present invention.

All of the disclosures including the claims, the patent specification, the attached drawings and the abstract of Japanese Patent Application No. 2009-090029 filed on Apr. 2, 2009 are herein incorporated by reference.

What is claimed is:

1. An image forming system comprising:
an image forming apparatus to form an image on a sheet conveyed from a feeding section to eject the sheet; and
a plurality of finishers each including one or a plurality of ejection trays, which finishers are connected to the image forming apparatus and perform finishing to the sheet ejected from the image forming apparatus,
wherein the image forming apparatus includes a control section to determine a sheet feeding interval of the feeding section based on a position of the ejection tray to which a first sheet is ejected and a position of the ejection tray to which a second sheet is ejected, an image-forming order of the second sheet being immediately before an image-forming order of the first sheet.

2. The image forming system of claim 1,
wherein the image forming apparatus transmits to the finishers sheet information including information for specifying any of the ejection trays to which the sheet is ejected,
each of the finishers further includes a control section to calculate a necessary time for conveyance of the sheet based on the sheet information, and
the control section of the image forming apparatus determines the sheet feeding interval of the feeding section based on the necessary time for conveyance calculated by the control section of each of the finishers.

3. The image forming system of claim 2,
wherein the control section of the image forming apparatus allows a time obtained by adding a time difference between the necessary time for conveyance of the first sheet and the necessary time for conveyance of the second sheet to a previously-set predetermined sheet ejection interval to be the sheet feeding interval of the feeding section.

4. The image forming system of claim 2,
wherein the sheet information includes information regarding the ejection tray to which the sheet is ejected, a content of finishing, and a sheet size.

5. The image forming system of claim 1,
wherein the sheet feeding interval of the feeding section determined by the control section is different for each of combinations of the ejection trays to which the first sheet and the second sheet to be sequentially image-formed are respectively rejected, and sheet ejection intervals for the combinations are equal to one another when the sheets fed based on the sheet feeding interval are respectively ejected to the ejection trays.

6. An image forming apparatus which is connected to a plurality of finishers each including one or a plurality of ejection trays so as to enable a data transmission and reception, and which apparatus forms an image on a sheet conveyed from a feeding section to eject the sheet, the image forming apparatus comprising:
a control section to determine a sheet feeding interval of the feeding section based on a position of the ejection tray to which a first sheet is ejected and a position of the ejection tray to which a second sheet is ejected, an image-forming order of the second sheet being immediately before an image-forming order of the first sheet.

7. The image forming apparatus of claim 6, further comprising:
a communication section to transmit to the finishers sheet information including information for specifying any of ejection trays to which the sheet is ejected, and to receive from the finishers a necessary time for conveyance of the sheet, and
wherein the control section determines the sheet feeding interval of the feeding section based on the necessary time for conveyance received by the communication section.

8. The image forming apparatus of claim 6,
wherein the sheet feeding interval of the feeding section based on the sheet information including information for specifying any of the ejection trays to which the sheet is ejected.

9. The image forming apparatus of claim 7,
wherein the sheet information includes information regarding the ejection tray to which the sheet is ejected, a content of finishing, and a sheet size.

10. The image forming apparatus of claim 8,
wherein the sheet information includes information regarding the ejection tray to which the sheet is ejected, a content of finishing, and a sheet size.

11. The image forming apparatus of claim 6,
wherein in image formation performed by the image forming apparatus, the sheet feeding interval of the feeding section determined by the control section is different for each of combinations of the ejection trays to which the first sheet and the second sheet to be sequentially image-formed are respectively rejected, and sheet ejection intervals for the combinations are equal to one another when the sheets fed based on the sheet feeding interval are respectively ejected to the ejection trays.
